(19) United States
(12) Patent Application Publication
(10) Pub. No.: US 2006/0282508 A1
(43) Pub. Date: Dec. 14, 2006

(54) System and method of responding to a flood attack on a data processing system

(75) Inventors: Venkat Venkatsubra, Austin, TX (US); Richard Perry Youngman, Cedar Park, TX (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 11/149,185

(22) Filed: Jun. 9, 2005

(51) Int. Cl. G06F 15/16

(52) U.S. Cl. 709/217; 709/228

(57) ABSTRACT

A system and method of responding to a flood attack on a data processing system is disclosed. The present invention mitigates the affects of SYN attacks with false IP addresses by immediately removing the associated embryonic connection from the system upon receiving notification that the IP address in the original SYN request is false. Immediate removal of the connection request will mitigate the effects of the flood attack by not requiring the system to devote resources to servicing a connection request from a false IP address, which could result in denial of service for legitimate clients. Immediate removal of the connection request will mitigate the effects of the flood attack by not requiring the system to devote resources to servicing a connection request from a false IP address, which could result in denial of service for legitimate clients.

### BACKGROUND OF THE INVENTION

1. Technical Field

The present invention relates in general to the field of data processing systems, and specifically, the field of networked data processing systems. Still more particularly, the present invention relates to a system and method of handling connection requests between networked data processing systems.

2. Description of the Related Art

Transmission Control Protocol (TCP) is one of the most widely-used transmission protocols on the Internet. Because TCP provides a reliable and in-order byte stream between two points of communication, applications utilizing TCP do not have to keep track of data lost or re-ordered during transmission.

To establish connections utilizing TCP, the sending and receiving hosts perform a three-way handshake. First, the sending host (host A) send receiving host (host B). The SYN signal indicates to host B that host A is ready to transmit. After host B receives the SYN signal from host A, host B sends a SYN-ACK message that indicates that host B acknowledges and accepts the connection. If host A receives the SYN-ACK message, host A will respond with a second ACK message, after which traffic can flow over the established TCP connection.

However, the TCP connection process includes several disadvantages. For example, since severs such as host A and host B typically service multiple connections, connection requests in the form of SYN signals are usually placed on a TCP connection queue (hereinafter referred to as an “embryonic queue). All embryonic queues are finite in length, and may become saturated due to dynamic factors such as connection receipt rate, available system resources, protocol response, application behavior, and malicious attacks.

In particular, it is well-known by those with skill in this art, that the current method of establishing TCP connections leaves servers vulnerable to SYN Flood attacks by hackers seeking to disable the networking capability of the server. A “SYN Flood attack” involves a client transmitting a stream of SYN messages with false source Internet Protocol (IP) addresses. As previously discussed, the server receiving the stream of SYN messages allocates memory to each SYN message and sends out an SYN/ACK message to the source IP address listed in the original SYN message. The server will then wait for an ACK message from the client listed at the source IP address. However, during a SYN flood attack, the SYN messages contain a false source IP address. Therefore, the server will never receive an ACK message to the sent SYN/ACK message because the computer purported to be located at the listed source IP address will probably not exist. The queue that handles the SYN messages will be quickly filled with SYN messages with false source Ip addresses, thus preventing valid connection requests from being serviced by the server. Therefore, there is a need for a system and method of responding to SYN flood attacks.

### SUMMARY OF THE INVENTION

A system and method of responding to a flood attack on a data processing system is disclosed. A preferred embodiment of the present invention mitigates the affects of SYN flood attacks with false IP addresses by removing, independently of any time delay, the associated connection request from the system queue upon receiving notification that the IP address in the original SYN request is false. Immediate removal of the connection request will mitigate the effects of the flood attack by not requiring the system to devote resources to servicing a connection request from a false IP address, which could result in denial of service for legitimate clients.

The above-mentioned features, as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is a block diagram illustrating an exemplary network in which a preferred embodiment of the present invention may be implemented;

FIG. 2 is a block diagram depicting an exemplary data processing system in which a preferred embodiment of the present invention may be implemented;

FIG. 3 is a high-level flowchart diagram illustrating a TCP connection protocol according to a preferred embodiment of the present invention; and

FIG. 4 is a high-level flowchart diagram depicting a method of handling a flood attack on a data processing system according to a preferred embodiment of the present invention.

### DETAILED DESCRIPTION OF THE PREFERRED EMBODIMENT

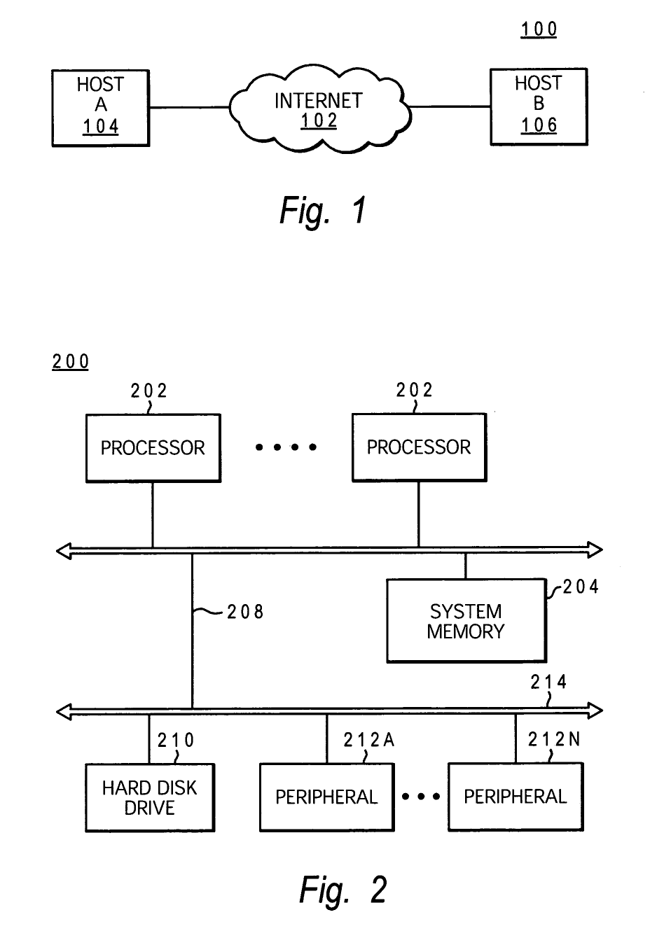

Now referring to the figures, and in particular, with reference to FIG. 1, there is depicted an exemplary network 100 in which a preferred embodiment of the present invention may be implemented. As depicted, network 100 includes Internet 102, host A (client) 104, and host B (server) 106. In a preferred embodiment of the present invention, host A 104 seeks to establish a connection with host B 106 via Internet 102.

Those skilled in the art will appreciate that network 100 can include many additional components (e.g., routers, firewalls, etc.) not specifically illustrated in FIG. 1. Because such additional components are not necessary for an understanding of the present invention, they are not illustrated in FIG. 1 or discussed further herein.

With reference now to FIG. 2, there is depicted an exemplary data processing system 200 in which a preferred embodiment of the present invention may be implemented. As illustrated, exemplary data processing system 200 may be implemented on a general purpose computer, such as one of the members of the IBM-compatible family of computers, or one of several workstation or graphics computer devices which are presently commercially available. Host A 104 and host B 106 may be implemented as a data processing system such as data processing system 200.

As depicted, exemplary data processing system 200 includes processor(s) 202, which are coupled to system memory 204 via system bus 206. Preferably, system memory 204 may be implemented as a collection of dynamic random access memory (DRAM) modules. Typically, system memory 204 includes data and instructions for running a collection of applications. Mezzanine bus 208 acts as an intermediary between system bus 206 and peripheral bus 214. Those with skill in this art will appreciate that peripheral bus 214 may be implemented as a peripheral component interconnect (PCI), accelerated graphics port (AGP), or any other peripheral bus. Coupled to peripheral bus 214 is hard disk drive 210, which is utilized by data processing system 200 as a mass storage device. Also coupled to peripheral bus 214 are a collection of peripherals 212a-n.

Those skilled in the art will appreciate that data processing system 200 can include many additional components not specifically illustrated in FIG. 2. Because such additional components are not necessary for an understanding of the present invention, they are not illustrated in FIG. 2 or discussed further herein. It should also be understood, however, that the enhancements to data processing system 200 to improve handling of TCP connection requests and response to SYN flood attacks provided by the present invention are applicable to data processing systems of any system architecture and are in no way limited to the generalized multi-processor architecture or symmetric multi-processing (SMP) architecture illustrated in FIG. 2.

A preferred embodiment of the present invention, network 100 of FIG. 1, includes two data processing systems that operate in a client-server configuration. Those with skill in this art will appreciate that the present invention is not limited to a client-server configuration and may be implemented utilizing other network configurations including, but not limited to mainframes networks, file-sharing networks, and peer-to-peer networks.

Frequently, networks such as network 100 utilize various protocols to enable connectivity between parts of the network. While a preferred embodiment of the present invention utilizes the transmission control protocol (TCP), those with skill in this art will appreciate that the system and method disclosed in the present invention are applicable to other communications protocols such as Winsock, NetBIOS, etc.

In a preferred embodiment of the present invention, TCP operates as an extension of the operating system kernel. That is, the operating system enables TCP operations to be carried out without extra TCP programs. However, in some embodiments of the present invention, TCP operations may be handled utilizing specialized TCP programs.

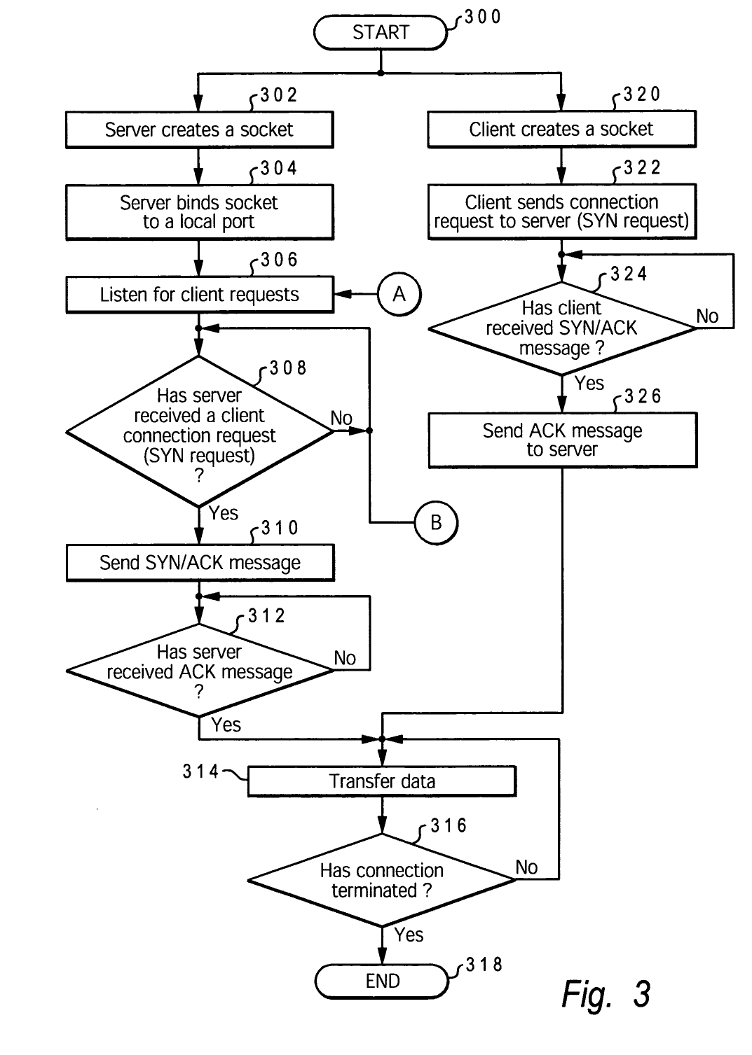

FIG. 3 is a high-level flowchart diagram illustrating an exemplary client-server interaction in which a preferred embodiment of the present invention may be implemented. This exemplary client-server interaction represents a server creating a socket to listen for connection requests, fielding those requests, and transferring data between the server and the client. Also, the client creates a socket to communicate with the server, connects to the server via the socket, and transfers data between the client and the server.

As illustrated, FIG. 3 is divided into two interacting parts, one representing the actions taken by the server (blocks 302-312), and the other representing the actions taken by the client (blocks 320-326). With respect to the server, the process begins at step 300 and proceeds to step 302, which illustrates the server creating a socket to enable the server to communicate with clients. Sockets are utilized by computer systems for communication between processes either within a single computer system or across a network such as the internet.

The process then proceeds to step 304, which depicts the server binding the socket to a local port in the server. Then, the process continues to step 306, which illustrates the server listening for client requests through the local port via the socket. Then, as illustrated in step 308, the server determines whether a TCP connection request has been received from a client. If a TCP connection request has not been received by the server, the process iterates at step 308. However, if a TCP connection request has been received by the server, the process continues to step 310, which depicts the server sending a SYN/ACK request to acknowledge and accept the SYN request from the client.

Then, as depicted in step 312, the server determines whether or not an ACK message has been received from the client. If the server determines an ACK message has not been received from a client, the process iterates at step 312. However, if the server determines an ACK message has been received from a client, the process continues to step 314, which illustrates the server and client transferring data over the established connection. The process then continues to step 316, which illustrates the server determining whether or not the connection between the server and client has been terminated, either through an explicit connection termination or a connection time-out. If the connection has not been terminated, the process returns to step 314 and proceeds in an iterative fashion. If, however, the server determines that the connection has terminated, the process proceeds to step 318, which illustrates the process end.

With respect to the client, the process begins at step 300 and proceeds to step 320, which illustrates the client creating a socket and binding that socket to a local port for communication with the server. Then, as depicted in step 322, the client sends a connection request to the server, preferably in the form of a SYN request. Then, the client determines whether it has received a SYN/ACK message from the server, as illustrated in step 324. If the client has not received a SYN/ACK message from the server, the process iterates at step 324. However, if the client has received a SYN/ACK message from the server, the process continues to step 326, which illustrates the client sending an ACK message to the server, which completes the three-way handshake procedure and enables the server and the client to form a connection. Then, the server and client begin transfer of data, as illustrated in step 314. Periodically, as previously discussed, the server and client determine whether or not the connection has been terminated, as depicted in step 316. If the connection has not been terminated, the process returns to step 314 and proceeds in an iterative fashion. If the connection has been terminated, the process continues to step 318, which depicts the process ending.

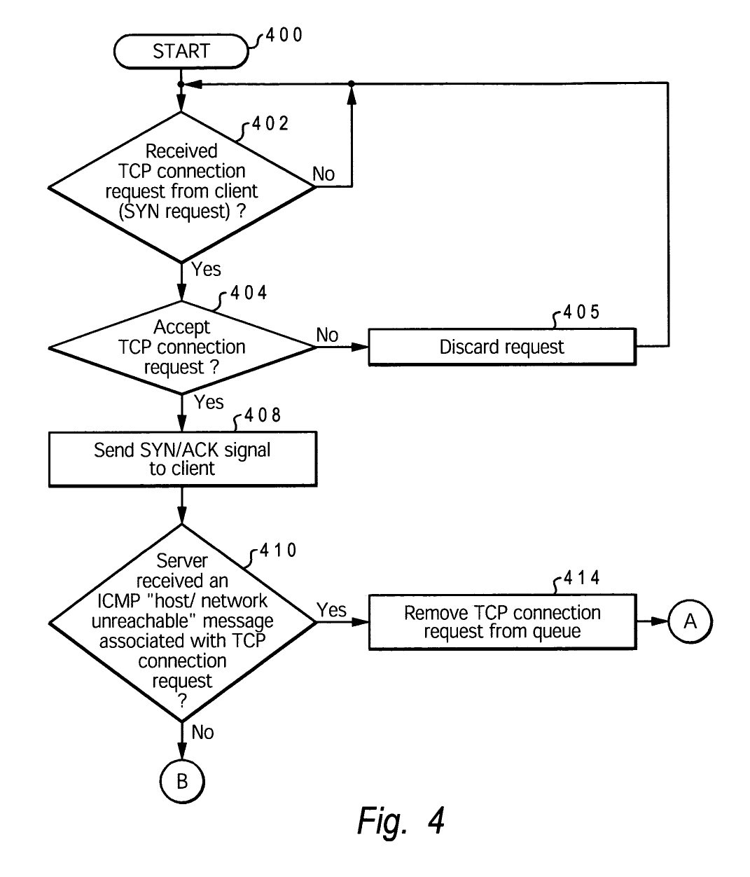

FIG. 4 is a flowchart diagram depicting a method of responding to SYN flood attacks according to a preferred embodiment of the present invention. The process begins at step 400 and continues to step 402, which illustrates a server determining whether it has receiving a TCP connection request (in the form of a SYN signal) from a client seeking to establish a connection with the server. If the server has not received a TCP connection request, the process iterates at step 402. However, if the server has received a TCP connection request, the process continues to step 404, which depicts the server determining whether to accept the received TCP connection request.

If the server decides not to accept the received TCP connection request, the process proceeds to step 406, which illustrates the server discarding the received TCP connection request. The process then returns to step 402 and continues in an iterative fashion. However, if the server decides to accept the received TCP connection request, the process continues to step 408, which depicts the server sending a SYN/ACK signal and placing the TCP connection request on an embryonic queue. As previously discussed, the SYN/ACK signal indicates to the client that the server has received the initial SYN signal and has agreed to accept the connection request. The embryonic queue orders TCP connection requests received by the server.

Then, the process continues to step 410, which illustrates a determination made of whether the server has received an Internet Control Message Protocol (ICMP) “Host/Network unreachable” message corresponding to the received TCP connection request. If the server has received such a message, the process continues to step 414, which illustrates the server removing, independently of any time delay, the TCP connection request from the embryonic queue. A ICMP “Host/Network unreachable” message indicates to the server that the TCP connection request may include a false internet protocol (IP) source address, which is characteristic of a SYN flood attack. The process then proceeds to marker A, which returns the process to step 306 in FIG. 3. However, if the server has not received such a message, the process proceeds to marker B, which returns to step 310 in FIG. 3. By removing the TCP connection request with the false IP address, the server can release the resources formally devoted to servicing that particular TCP connection request and devote the released resources to accepting connection requests from other clients. The effectiveness of a SYN flood attack, which “floods” the embryonic queue of a server to prevent the server from servicing valid request would be mitigated by implementing the present invention.

As disclosed the present invention includes a system and method of responding to a flood attack on a data processing system. The present invention includes mitigating the affects of SYN flood attacks with false IP addresses by removing, independently of any time delay, the associated connection request from the system queue upon receiving notification that the IP address in the original SYN request is false. Immediate removal of the connection request will mitigate the effects of the flood attack by not requiring the system to devote resources to servicing a connection request from a false IP address, which could result in denial of service for legitimate clients.

Also, it should be understood that at least some aspects of the present invention may alternatively implemented in a program product. Programs defining finctions on the present invention can be delivered to a data storage system or a computer system via a variety of signal-bearing media, which include, without limitation, non-writable storage media (e.g., CD-ROM), writable storage media (e.g., floppy diskette, hard disk drive, read/write CD-ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A data processing system comprising:
a processor;
an interconnect; and
as system memory, coupled to said processor via said interconnect, wherein said system memory stores a connection manager, wherein in response to receiving a notification that a connection request includes a false IP address, said connection manager, independently of any time delay, removes said connection request from a list of pending connection requests.

2. The data processing system according to claim 1, wherein said notification is an ICMP “Host/Network Unreachable” message corresponding to said connection request.

3. The data processing system according to claim 1, wherein said connection manager immediately removes said connection request from said list of pending connection requests to mitigate effects of a flood attack.

4. The data processing system according to claim 1, wherein said connection manager frees resources devoted to processing said connection request in response to removing said connection request from said list of pending connection requests.

5. A method comprising:
receiving a connection request;
queuing said connection request and sending a response to said connection request; and
in response to receiving a notification that said connection request includes a false IP address, removing, independent of any time delay, said connection request from a list of pending connection requests.

6. The method according to claim 5, wherein said notification is an ICMP “Host/Network Unreachable” message corresponding to said connection request.

7. The method according to claim 5, wherein said immediately removing said connection request further comprises:
immediately removing said connection request from said list of pending connection requests to mitigate effects of a flood attack.

8. The method according to claim 5 further comprises:
freeing resources devoted to processing said connection request in response to removing said connection request from said list of pending connection requests.

9. A computer-readable medium for storing a computer program product that comprises instructions for:
receiving a connection request;
queuing said connection request and sending a response to said connection request; and
in response to receiving a notification that said connection request includes a false IP address, removing, independent of any time delay, said connection request from a list of pending connection requests.

10. The computer-readable medium according to claim 9, wherein said notification is an ICMP “Host/Network Unreachable” message corresponding to said connection request.

11. The computer-readable medium according to claim 9, wherein said immediately removing said connection requests further comprises:
immediately removing said connection request from said list of pending connection requests to mitigate effects of a flood attack.

12. The computer-readable medium according to claim 9 further comprises:
freeing resources devoted to processing said connection request in response to removing said connection request from said list of pending connection requests.
